(19) United States
(12) Patent Application Publication
(10) Pub. No.: US 2006/0238317 A1
(43) Pub. Date: Oct. 26, 2006

(54) Wireless trailer light system

(76) Inventor: Neal Evan Colledge, Lehi, UT (US)

Correspondence Address: Neal E. Colledge, 695 West 1200 North, Lehi, UT, 84043, US

(21) Appl. No.: 11/233,834

(22) Filed: Sep. 22, 2005

Related U.S. Application Data
(60) Provisional application No. 60/674,219, filed on Apr. 22, 2005.

(51) Int. Cl. G08B 21/00

(52) U.S. Cl. 340/431

(57) ABSTRACT

A trailer light system. The system includes a transmitter and a receiver. The transmitter is placed on the towing vehicle and connected to various signal lights, tail lights, brake lights, and clearance lights. When the towing vehicles turn signals, tail lights, or stop lights are activated an analog or digital signal is sent to the receiver located on the trailer and the corresponding trailer's light is activated. The receiver is constructed in such a manor that it can be removed from one trailer and reconnected to another trailer to enable the owner to use the same trailer light system on several different trailers while using the same towing vehicle.

### BACKGROUND OF THE INVENTION

1. The Field of the Invention

The present invention relates generally to a wireless system that will activate the lights of a trailer when it is being towed by a vehicle. More particularly, it concerns a transmitter on a vehicle sending a analog or digital signal to a receiver mounted on a trailer which in turn activates the various turn signals, stop lights, or tail lights on the trailer.

2. The Background Art

The purpose of the “Wireless Trailer Light System” is to eliminate the need for wires connecting the towing vehicle to the trailer. History has shown that these wires and connectors can become corroded, or be pulled away from the vehicle or trailer and there by require a large amount of maintenance.

With these and other disadvantages in mind, applicant seeks to provide a wireless system that will overcome the limitations and disadvantages of prior systems and will provide a number of significant advantages.

### OBJECTS AND SUMMARY OF THE INVENTION

Therefore, it is an object of the present invention to provide a “Wireless Trailer Light System” that is simple in design and manufacture.

It is a further object of this invention to provide a way to eliminate the use of wires or connectors from the towing vehicle to the trailer.

It is another object of the present invention to provide an effective and reliable method of transmitting an analog or digital signal from the towing vehicle to the trailer.

It is an additional object of this invention to provide a way that is effective and easy for the same wireless system to be used with several trailers and the same towing vehicle.

The above objects and other not specifically recited are reached in a specific illustrative embodiment of a wireless trailer system device.

Additional object and advantages of the invention will be set forth in the description which follows, and in part will be apparent from the invention without undue experimentation. The objects and advantages of the invention may be realized and obtained by means of the instruments and combinations particularly pointed out in the appended claims.

### BRIEF DESCRIPTION OF THE DRAWINGS

The above and other objects, features, and advantages of the invention will become apparent from a consideration of the subsequent detailed description presented in connection with the accompanying drawings in which:

FIG. 1 is a top perspective view of the “Wireless Trailer Light System”.

FIG. 2 is a side view of the weather resistant compartment which houses the rechargeable battery and the portable receiver.

### DETAILED DESCRIPTION

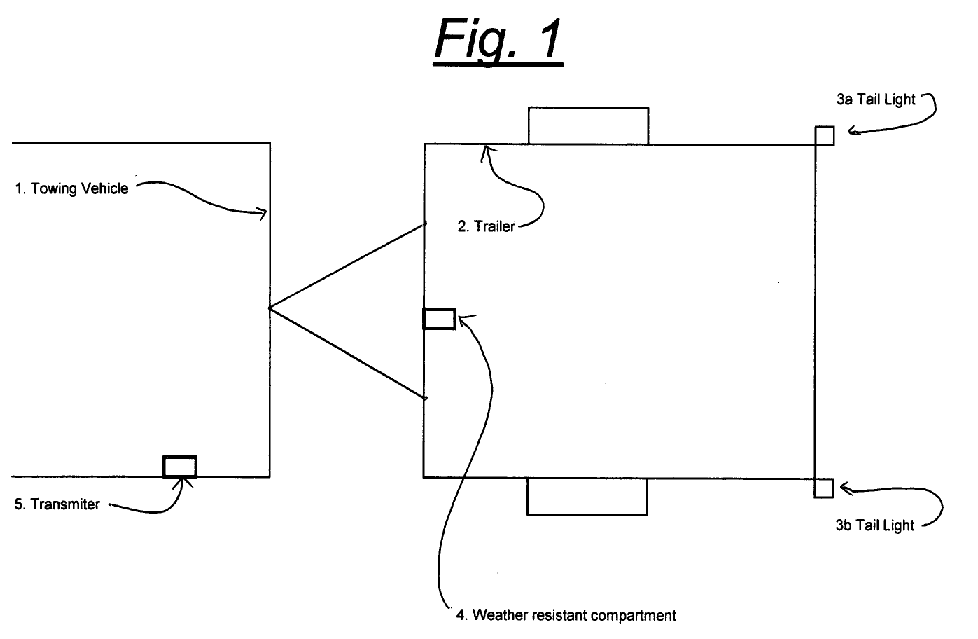

An embodiment of the present invention is illustrated by FIG. 1 which is a top perspective view of the Wireless Trailer Light System.

1. Towing vehicle

2. A transmitter is mounted on the towing vehicle in any location that is convenient. Example of which might be, the engine compartment, the cab under the dash board, under the body attached to the frame etc. Wires are connected to each of the vehicles tail light, stop lights, or turn signals lights. This will enable a signal to be transmitted from the transmitter when signal lights, tail lights etc. are activated.

3a & 3b. The tail lights will consist of LED (light emitting diode) bulbs in an attempt to minimize the use of electricity from the battery.

4. A weather proof box or compartment is mounted to the trailer in an area where it will be protected as much as possible from the elements. Wires from each of the tail lights or clearance lights are connected to a female plug which is located inside the weather proof compartment.

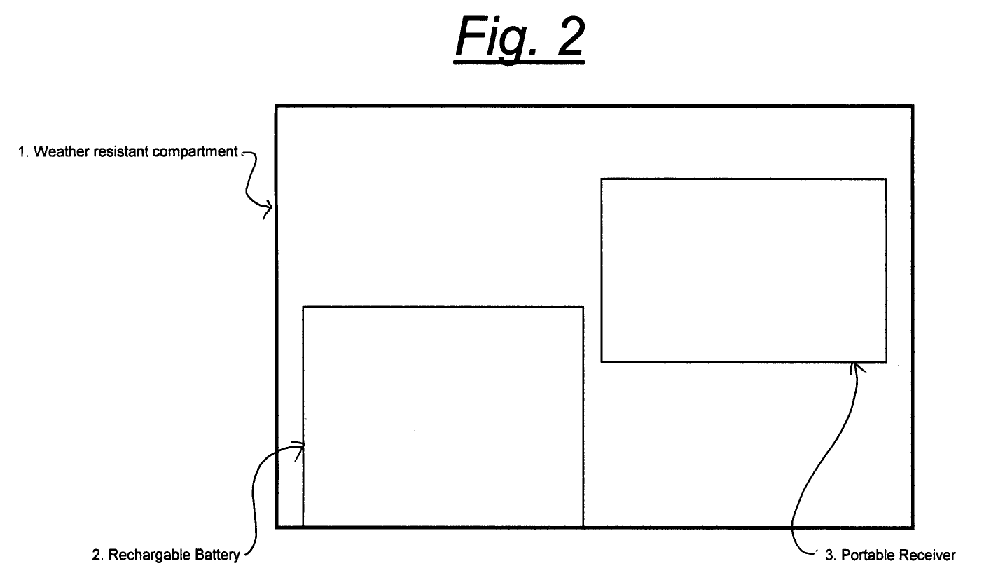

FIG. 2

1. Weather resistant compartment

2. The power source to operate the light on the trailer will be supplied by a rechargeable battery that is housed inside the weather proof compartment.

3. An analog or digital receiver has been manufactured to be able to be inserted into a female plug inside the weather proof compartment. The purpose for the receiver being able to be removed is to make it possible for it to be used on other trailers that are compatible with this system.

4. The power source to operate the light on the trailer will be supplied by a rechargeable battery that is also housed inside the weather proof compartment.

5. The tail lights will consist of LED (light emitting diode) bulbs in an attempt to minimize the use of electricity from the battery.

The battery will periodically require recharging. This can be achieved by several different methods.

1. A solar panel can be mounted somewhere on the trailer and connected to the battery for recharging purposes.

2. A wind propelled generator could also be mounted on the trailer so when the trailer is being towed the wind turbulence can activate the generator and in turn recharge the battery.

3. A generator could be attached to the wheels of the trailer so when the trailer is in motion the wheels are turning the generator and producing power to recharge the battery.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment (s) of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A trailer light system that eliminates the use of wires from the towing vehicle to the trailer.

2. The trailer light system of claim 1, wherein a transmitter, mounted on the towing vehicle, sends an analog or digital signal to a receiver mounted on the trailer.

3. The trailer light system of claim 2, wherein the said receiver will activate tail lights, stop lights, signal light, clearance lights and also trailer brake lights.

4. The trailer light system of claim 3, wherein the said receiver is transferable from one trailer to another.

5. The trailer light system of claim 3, wherein the receiver is housed in a waterproof device to protect it from the elements.
